(19) United States
(12) Patent Application Publication
(10) Pub. No.: US 2019/0101489 A1
(43) Pub. Date: Apr. 4, 2019

(54) Method and Apparatus for Simultaneously Measuring 3Dimensional Structures and Spectral Content of Said Structures

(71) Applicant: Michael John Darwin, Portland, OR (US)

(72) Inventor: Michael John Darwin, Portland, OR (US)

(21) Appl. No.: 16/146,500

(22) Filed: Sep. 28, 2018

Related U.S. Application Data
(60) Provisional application No. 62/565,177, filed on Sep. 29, 2017.

(51) Int. Cl. G01N 21/31; G02B 26/10; G02B 21/12; G02B 21/00; G01B 11/24

(52) U.S. Cl. CPC G01N 21/31; G02B 26/105; G01B 11/24; G02B 21/0032; G02B 21/0048; G02B 21/12

(57) ABSTRACT

A method and apparatus for the generation of 3Dimensional data and hyperspectral images for an object consisting of one or more broadband light projection systems, a means of generating a light pattern or structure, one or more sensors for observing the reflected light, one or more sensors for registering position, one or more electronic means of synchronizing and extracting data from the sensor, one or more calibration methods for rationalizing the data, and one or more algorithms for analyzing the data to reproduce the 3D structure and spectral content of the structure.

### CROSS REFERENCE TO RELATED APPLICATION

This application claims the benefit of U.S. Provisional Application No. 65/565177 filed on Sep. 29, 2017, entitled “Method and Apparatus for Simultaneously Measuring 3Dimensional Structures and Spectral Content of Said Structures.”

### BACKGROUND OF INVENTION

### Field of Invention

The present invention relates to the non-contact methods and apparatus used for measuring the geometry of a sample as well as the spectral content of the light coming from the measured sample; the spectral content can be mapped from one or more surfaces or volumes of the sample. Several industries rely on geometrical measurements to insure quality control, sound manufacturing practices, and in some cases, these geometrical measurements are directly integrated into manufacturing tools for process control. Many of these same industries also monitor and control the chemical composition of the materials used in the process through the utilization of optical spectroscopy methods. Additional applications can be found in the biological imaging space in which specific optical signatures are programmed into a sample by optically active chromophores that signal specific chemical changes or the presence of certain chemical species.

In one practical case of Semiconductor Backend of Line processing, some manufactures deposit/grow copper pillars or bumps on the integrated circuit (IC) as one of the last processing steps before attaching the IC to a substrate. Control of the Bump Height and Bump Diameter are considered critical process parameters to control due to the impact on electrical properties of the integrated IC, or more severely on yield, if they are not processed correctly. Additionally, these Copper pillars and bumps can be electrically connected using redistribution layers in which copper traces are imbedded in a matrix of dielectric material; monitoring the thickness, uniformity, and chemical properties of these dielectric layer is often done via optical spectroscopy. Fully automated wafer handling systems have been created to inspect and measure, in some cases each silicon wafer, integrated circuit chip, as well as each bump on the IC; in most cases statistical sampling is used to monitor these processing steps.

Another rapidly growing market is the additive manufacturing, in which objects are “printed” using a variety of techniques. These objects can either be components or finished products and either designed from scratch or are imaged and reproduced. In the case of design from scratch, quality control of the 3D printed object can be monitored with geometric measurement tools to insure the appropriate manufacturing tolerance has been achieved. In the case of replication, a sufficiently accurate “shell/surface” can be used to emulate the desired object, with the end user defining the internal matrix under constraints of weight, strength, and and/or function. Additionally, much research is underway about functionalizing 3D printed objects, that is printing regions within or on a 3D structure that has different properties or functionalizing these regions (such as the use of embedded IOT devices, temperature sensors, pressure sensors, or various active devices). Monitoring these processes real time, that is during the print process, will likely be required to insure quality and yield of the final product.

Yet another market that is seeing rapid growth is in the use of optical imaging as applied to fluorescence microscopy, typically applied to biological samples. Much research and development requires the use of high power, super resolution, and/or confocal microscopes that image biological and/or chemical processes having been marked with optically active chromophores; in other words, illuminating the sample at a certain wavelength will stimulate emission at a different wavelength if the chromophore has been activated. Typically (11, 12 for example) confocal systems are used to reconstruct the location of the emission, and thus the chemical structure of the sample. Further yet, massively parallel lab on chip techniques are exploring optical approaches in the studies of various chemical reaction (13, 14).

### Description of Prior Art

Much prior art exists for systems that use structured light for three-dimensional scanning. Prior to the disclosed system, many structured light measuring system use a quasi-static projection (1, 2, 3 and references therein, 18) of light and analyze the subsequent captured images. A few of these approaches will analyze the bend or distortion in the line as a direct measure of displacement, as well as the width of the projected lines as a measure of surface curvature. In some cases, historical approaches will use a Fourier transform of the captured image to extract out the spatial frequencies of the measured surface to enable surface reconstruction. In most all cases, the historical systems use multiple line widths and pitches in the structured light to uniquely identify the phase shift. Many of these approaches could be considered static or unmodulated approaches and thus subject to higher background noise. Some of these approaches use shifting/moving light structure to enhance the signal (4, 5, 8).

Likewise, prior art exists for the use of hyperspectral imaging, in which systems may use a form of scanning to extract information; the scanning can either be in the spatial dimension or in the wavelength dimension. Most hyperspectral imaging (HSI) devices that use spectral scanning rely on a 2D imaging devices and a method to create monochromatic light using a band pass filter. Some methods utilize non-scanning approaches and rely on mechanical and/or optical filters to capture subsequent images at various wavelengths. Additional methods use a high-speed CHIRPing to collect hyperspectral images (16).

References for describing Confocal systems for achieving similar information can be found in numerous locations in the public domain (March 2002 Materials Today for example). Many confocal systems use specific laser wavelengths to both simultaneous overcome the inherent lack of flux through the optical system while stimulating emissions; these systems can also be used for 3D measurements, by slicing their way through a sample (aka taking scans at various heights). Confocal systems may be well suited for a few biological markers and small fields of view; however, they are not the best choice for broadband measurements or measurements in which speed is critical due to the chromatic scanning nature of these systems.

### BRIEF DESCRIPTION OF THE DRAWINGS

FIG. 1 System layout consisting of a brightfield light source, imaging and collimation optics, full and partially reflective mirrors, a spatial light modulator, a tunable wavelength filter (such as an acousto-optic transmission filter AOTF), a sensor capable of measuring the structured light across multiple wavelengths, multiple electronic drivers capable of synchronizing the spatial light modulator and the tunable filter, and a computer system that will be used to synchronize, gather and analyze data. In this system layout, the spatial light modulator and wavelength filter are on the illumination leg of the apparatus in a brightfield configuration with the sample illumination being reflected from a partially reflective mirror.

FIG. 2 One possible process flow for the synchronization and generation of data in which the data stream is first stored and then subsequently analyzed for position, amplitude, and phase information.

FIG. 3 An alternative possible process flow for the synchronization and generation of data in which the data stream is analyzed for position, amplitude, and phase information electronically, and then subsequent output is then stored.

### DETAILED DESCRIPTION OF INVENTION

Reference is made herein to the attached drawings. Like reference numerals are used throughout the drawings to explain elements of one embodiment of the measuring instrument. For the purpose of presenting a brief and clear description of the invention, one embodiment will be discussed as used for the measurement of signal phase and amplitude as a function of wavelength. The figures are intended for representative purposes only and should not be considered limiting in any aspect.

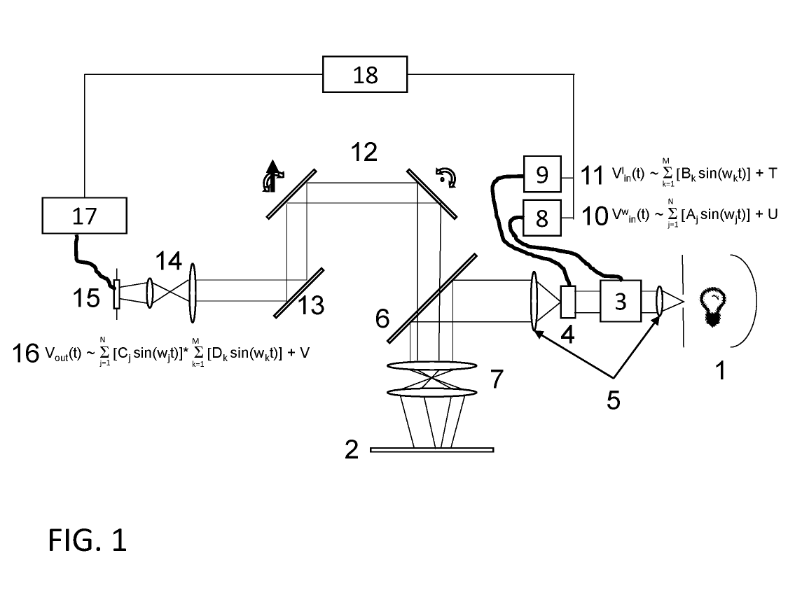

Referring to FIG. 1, a brightfield light source capable of broadband illumination 1 is projected onto the sample area 2. The light passes through or reflected from a tunable wavelength filter 3, a spatial light modulator 4, a set of collimated or near collimating optics 5, a beam splitting/half silvered mirror 6, and imaging optics 7. The wavelength of the tunable filter 3 is modulated by driver 8 and the spatial frequency is modulated by driver 9. The drivers for the wavelength filter 8 and spatial light modulator 9 are phase locked such that the amplitude and phase of the projected light can be defined at each moment. This is similar to references (8, 16), in that the wavelength sweep represents a CHIRPed signal with a base frequency that can be locked to the spatial light modulation frequency while the spatial light modulation acts as a probe to height variations. The programmed phase locked driver frequencies are represented by their Fourier components shown in 10 and 11. Light from the sample is collected through the imaging optics 7 and transferred to the sensor 15 via the beam splitting/half silver mirror 6, galvanometric scanning mirrors 12, relay mirror(s) 13, and relay optics 14. For this representation of the invention, the galvanometric mirror pair 12 enable either a full or partial imaging of the sample area 2. For this embodiment, the sensor 15 can either be sampled fast enough, such that the highest represented frequency in the illumination is captured or the sensor 15 can be programmed to sub sample at the (or multiple thereof) repeat frequency with known phase offsets; the sensor 15, wavelength CHIRP, and spatial modulation must all be synchronized in phase to the same clock 18. The subsequent data stream will be represented by Fourier components 16, which will be proportional to a multiplication of the Fourier components from the illumination leg 10 and 11. The sensor data stream can either be analyzed by a computer with custom software or custom electronics 17. Additionally, the positions and/or movements of the galvanometric mirrors 12 can be synchronized with the data stream in 17. The result is a data hyper cube representing X and Y locations defined by the galvanometric mirrors 12 and the wavelength dependent reflectance and structured light relative phase values at those locations. The reflectance data can be normalized with respect to a known sample to remove the wavelength dependence of the light source and the structured light relative phase can be calibrated against a similar (or same) known sample to translate relative phase to relative height. The reflectance data can be subsequently modeled to determine material characteristics for bulk properties or thin film characteristics of the sample, such as film thickness; for sufficiently thick transparent films of known properties, subsurface topography and film thickness may also be extracted either by direct measurement or modeling. A null, or near null, condition in the spatially modulated phase is expected in the center of the field of view and can be addressed by either ignoring or filtering said data, or can be avoided by changing from the brightfield illumination as shown to a darkfield illumination configuration.

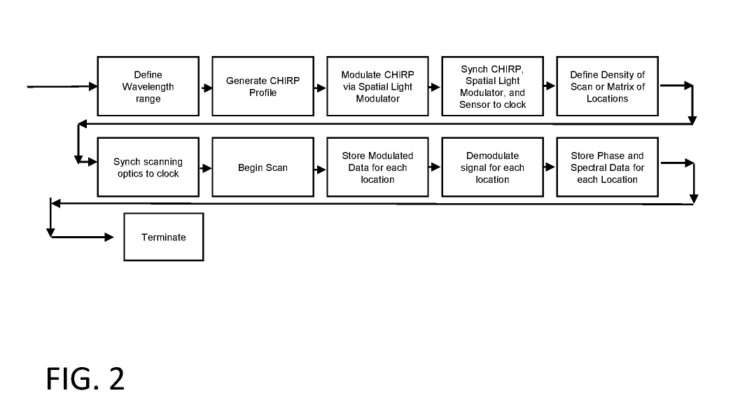

Referring to FIG. 2, one implementation of modulation and demodulation is presented. Within this scheme, the modulation occurs via hardware and their drivers and the demodulation occurs through an optimized software program using off the shelf hardware components. This approach stores all sampled data into computer memory, which is later recalled for demodulation and subsequent analysis. The demodulation happening via software can occur by either a Fourier analysis of the represented frequencies, time differencing, Lissajous analysis, product methods or by other accepted practices. A strict phase relationship between the CHIRP, spatial modulation, and sensor sampling frequency must be maintained. A comparison of wavelength dependent amplitude and phase data can be compared to a reference sample for calibration purposes.

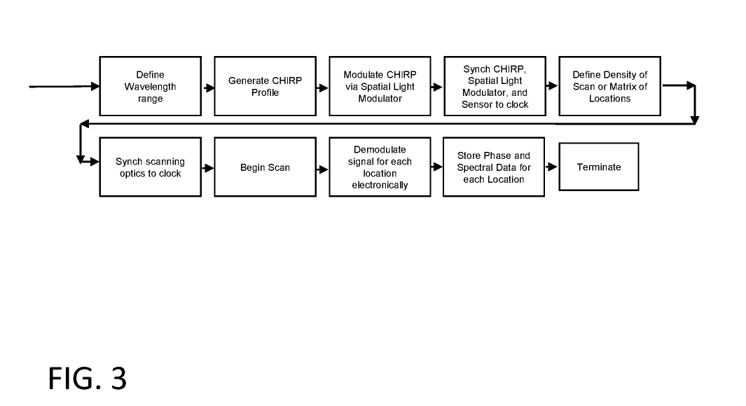

Referring to FIG. 3, an alternative implementation of modulation and demodulation is presented. Within this scheme, the modulation occurs via hardware and their drivers and the demodulation occurs through an optimized set of hardware and software components. In this approach, overhead associated with storing and recalling data can be avoided, while enabling near real-time demodulation of the signal.

### REFERENCES

1) U.S. Pat. No. 6,064,759 2000 Buckley et al.
2) U.S. Pat. No. 7,098,435 2006 Mueller et al.
3) U.S. Pat. No. 7,625,335 2009 Deichmann et al.
4) U.S. Pat. No. 6,771,807 2004 Coulombe et al.
5) U.S. Pat. No. 7,079,666 2006 Coulombe et al.
6) U.S. Pat. No. 7,433,058 2008 Cantin et al.
7) U.S. Pat. No. 4,742,237 1988 Ozawa.
8) U.S. patent application Ser. No. 15/925,121 [Assignee: Michael J. Darwin].
9) U.S. Patent Application 209/0236525 A1, Sep. 24, 2009 [Assignee: DRS Sensors & Targeting Systems, Inc].
10) U.S. Pat. No. 7,067,784 B1, Jun. 27, 2006 [QinetiQ Limited].
11) DE102014002514B4, Filing Date: 2014 Feb. 21 [Stuttgart University].
12) Nikon N-Storm, Super Resolution Microscope System, (http://www.nikoninstruments.com/Products/Super-resolution/N-STORM-Supper-Resolution)
13) Zeiss ELRYA, Super Resolution Microscope System, (https://www.zeiss.com/microscopy/us/products/superresolution-microscopy.html)
14) Isaac Rodríguez-Ruiz, Tobias N. Ackermann, Xavier Muñoz-Berbel, and Andreu Llobera, Photonic Lab-on-a-Chip: Integration of Optical Spectroscopy in Microfluidic Systems, Anal. Chem., 2016, 88 (13), pp 6630-6637, May 6, 2016.
15) S. Rampazzi, et al, ab on Chip: Portable Optical Device for On-site Multi-parametric Analysis, Digital System Design (DSD), 2013 Euromicro Conference, 4-6 Sep. 2013.
16) U.S. Patent Application 62/565,162 Filing date Sep. 29, 2017 [Assignee: Michael J. Darwin].

I claim:

1) A method for generating optical phase and wavelength information to extract surface topography, surface film characteristics, and hyperspectral content of an object or objects using a combination of spatial light and CHIRPed modulation, the method comprising one or more brightfield or darkfield light sources of sufficient bandwidth, a spatial light modulator, a tunable wavelength filter, one or more sensors capable of measuring signal from predefined areas of an object(s) with sufficient sampling capability to satisfy demodulation conditions.

2) A method for generating optical phase and wavelength information to extract surface topography, surface film characteristics, and hyperspectral content of an object or objects using a combination of spatial light and CHIRPed modulation, the method comprising one or more brightfield or darkfield light sources of sufficient bandwidth, a spatial light modulator, a tunable wavelength filter, an optomechanical scanning method to enable programmatic variable density sampling, and one or more sensors synchronized with the scanning with sufficient sampling capability to satisfy demodulation conditions.

3) A method for generating optical phase and wavelength information to extract surface and subsurface topography, surface and subsurface film characteristics, and hyperspectral content of an object or objects using a combination of spatial light and CHIRPed modulation, the method comprising one or more brightfield or darkfield light sources of sufficient bandwidth, a spatial light modulator, a tunable wavelength filter, with or without an optomechanical scanning method to enable programmatic variable density sampling, and one or more sensors synchronized with the scanning with sufficient sampling capability to satisfy demodulation conditions.
